(19) United States
(12) Patent Application Publication
(10) Pub. No.: US 2025/0089751 A1
(43) Pub. Date: Mar. 20, 2025

(54) SENECIOATE MODIFIER COMPOUNDS

(71) Applicant: ABSTRAX TECH INC., Tustin, CA (US)

(72) Inventors: Iain W.H. Oswald, Tustin, CA (US); Manuel E. Sosa Hernandez, Tustin, CA (US); Thomas J. Martin, JR., Tustin, CA (US); Marcos A. Ojeda, Tustin, CA (US); Astrid A.F. Gonzalez, Tustin, CA (US); Michael F.Z. Page, Pomona, CA (US); Kevin A. Koby, Tustin, CA (US)

(21) Appl. No.: 18/889,092

(22) Filed: Sep. 18, 2024

Related U.S. Application Data
(60) Provisional application No. 63/583,717, filed on Sep. 19, 2023.

(51) Int. Cl. A23L 27/00; A23L 27/20

(52) U.S. Cl. CPC A23L 27/88; A23L 27/202; A23L 27/2024; A23L 27/2026; A23L 27/2028; A23L 27/203

(57) ABSTRACT

An edible composition, an aerosol composition, a flavor composition, a fragrance composition, or an inhalable composition includes an ester compound such as methyl senecioate, ethyl senecioate, isopropyl senecioate, n-propyl senecioate, n-butyl senecioate, isoamyl senecioate, n-hexyl senecioate, or a combination of any two or more thereof.

### CROSS REFERENCE TO RELATED APPLICATIONS

This application claims the benefit of U.S. Provisional Application No. 63/583,717, filed Sep. 19, 2023, the disclosure of which is incorporated herein by reference in its entirety.

### FIELD

The present technology relates to various compositions, products, and methods that are capable of, or adapted to, providing, augmenting, or enhancing the aroma of a product. In particular, the present technology relates to senecioate compounds containing compositions products, and methods that are capable of, or adapted to, providing, augmenting, or enhancing the aroma or flavor of a product.

### BACKGROUND

The following discussion is provided to aid the reader in understanding the disclosure and is not admitted to describe or constitute prior art thereto.

Cannabis consumption has increased significantly over the last decade due to increased legalization. With this, new cultivars have been bred that produce a wide range of aromas. These aromas are produced by a wide range of different chemical compounds, including terpenes, volatile sulfur compounds (VSCs), esters, and other chemical classes. Organic small molecules containing the ester functional group are some of the most commonly found flavoring and fragrance compounds. These compounds are ubiquitous in nature, often contributing to the aromas of flowers, fruits, herbs, and other plants. They are commonly used to emulate desirable scents and flavors, typically for imparting sweet, fruity olfactory properties. For example, these compounds can have wide ranging aromas, including banana (isoamyl acetate), wintergreen-mint (methyl salicylate), and mango/fruity (isopropyl butyrate). These compounds can be used in food and beverage applications, aerosols, perfumes, and other areas where these aromas are desired.

### SUMMARY

According to a first aspect, a composition includes an ester compound such as methyl senecioate, ethyl senecioate, isopropyl senecioate, n-propyl senecioate, n-butyl senecioate, isoamyl senecioate, n-hexyl senecioate, or a combination of any two or more thereof; and a primary terpene compound such as β-myrcene, β-caryophyllene, limonene, α-pinene, β-pinene, valencene, ocimene, terpinolene, or a combination of any two or more thereof. In certain embodiments, the composition is an edible composition, an aerosol composition, a flavor composition, a fragrance composition, or an inhalable composition.

In certain embodiments, the composition includes about 0.01 wt % to about 10 wt % of the ester compound, based on the total weight of the composition. In certain embodiments, the composition includes about 0.01 wt % to about 5 wt % of the ester compound, based on the total weight of the composition. In certain embodiments, the composition includes about 0.01 wt % to about 1 wt % of the ester compound, based on the total weight of the composition. In certain embodiments, the composition includes about 0.01 wt % to about 0.5 wt % of the ester compound, based on the total weight of the composition. In certain embodiments, the primary terpene compound is present in an amount of from about 0.1 wt % to about 99 wt %, based on the total weight of the composition. In certain embodiments, the primary terpene compound is present in an amount of from about 0.1 wt % to about 95 wt %, based on the total weight of the composition. In certain embodiments, the composition further includes a secondary terpene compound such as humulene, linalool, bisabolol, nerol, phellandrene, terpineol, farnesene, fenchyl alcohol, geraniol, menthol, citronellol, citronellal, geranyl acetate, nerolidol, citral, or a combination of any two or more thereof. In certain embodiments, the secondary terpene compound is present in an amount of from about 0.01 wt % to about 50 wt %, based on the total weight of the composition. In certain embodiments, the composition further includes a second flavoring and/or fragrancing agent. In certain embodiments, the second flavoring and/or fragrancing agent may be present in an amount of about 0.000001% to about 90% by weight, based on the total weight of the composition.

In certain embodiments, the composition is an edible composition. In certain embodiments, the composition is a food or beverage product. In certain embodiments, the beverage is beer, an alcohol containing beverage, or other non-alcohol containing beverage product. In certain embodiments, the composition is an inhalation composition. In certain embodiments, the composition is a flavor and/or fragrance composition.

According to a another aspect, provided is a process or a method for augmenting or enhancing the aroma or taste of a product, the method including the step of adding to said product an ester compound such as methyl senecioate, ethyl senecioate, isopropyl senecioate, n-propyl senecioate, n-butyl senecioate, isoamyl senecioate, n-hexyl senecioate, or a combination of any two or more thereof; and a primary terpene compound such as β-myrcene, β-caryophyllene, limonene, α-pinene, β-pinene, valencene, ocimene, terpinolene, or a combination of any two or more thereof. In certain embodiments, the product is an edible product, an aerosol product, a flavor product, a fragrance product, or an inhalable product. In certain embodiments, the product is an edible product or an inhalable product. In certain embodiments, the edible product is a food or beverage product. In certain embodiments, the beverage is beer, any alcohol containing beverage, or other non-alcohol containing beverage product.

The foregoing summary is illustrative only and is not intended to be in any way limiting. In addition to the illustrative aspects, embodiments and features described above, further aspects, embodiments and features will become apparent by reference to the following drawings and the detailed description.

### BRIEF DESCRIPTION OF THE DRAWINGS

FIG. 1 represents structures of compounds discovered contributing to diesel-like cannabis odor.

FIG. 2 represents 2-Dimensional chromatograms of chromatogram showing the methyl, ethyl, and isopropyl groups identified in Snowdream strain.

FIG. 3 shows a comparison of mass spectra of methyl senecioate found in Bubba Kush (top) and the NIST Spectral Library v17 (2017) (bottom).

FIG. 4 shows a comparison of mass spectra of ethyl senecioate found in Bubba Kush (top) and the NIST Spectral Library v17 (2017) (bottom).

FIG. 5 shows a comparison of mass spectra of isopropyl senecioate found in Bubba Kush (top) and the NIST Spectral Library v17 (2017) (bottom).

FIG. 6 shows a comparison of mass spectra of n-butyl senecioate found in Bubba Kush (top) and the NIST Spectral Library v17 (2017) (bottom).

FIG. 7 shows a comparison of mass spectra of isoamyl senecioate found in Grape Pie x Do-Si-Do (top) and the NIST Spectral Library v17 (2017) (bottom).

FIG. 8 shows a comparison of mass spectra of n-hexyl senecioate found in Bubba Kush (top) and the NIST Spectral Library v17 (2017) (bottom).

FIG. 9 shows a comparison of mass spectra of n-propyl senecioate in Juiceman (top) and the NIST Spectral Library v17 (2017) (bottom).

### DETAILED DESCRIPTION

Various embodiments are described hereinafter. It should be noted that the specific embodiments are not intended as an exhaustive description or as a limitation to the broader aspects discussed herein. One aspect described in conjunction with a particular embodiment is not necessarily limited to that embodiment and can be practiced with any other embodiment(s).

As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term.

The use of the terms “a” and “an” and “the” and similar referents in the context of describing the elements (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the embodiments and does not pose a limitation on the scope of the claims unless otherwise stated. No language in the specification should be construed as indicating any non-claimed element as essential.

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified. As a non-limiting example, a reference to “X and/or Y” can refer, in one embodiment, to X only (optionally including elements other than Y); in another embodiment, to Y only (optionally including elements other than X); in yet another embodiment, to both X and Y (optionally including other elements).

Unless indicated otherwise, reference to “percent” is to be understood as “weight percent,” and reference to “ratio” is as a weight/weight ratio.

As used herein, the term “terpene compound” is understood to mean any organic compound that contains at least one isoprene subunit within its structure and their oxygenated derivatives.

As used herein, the terms “odor” and “aroma” are used interchangeably and represent the sensory attributes of certain substances perceptibly determined by the olfactory system.

As used herein, the term “flavoring agent” is understood to mean an additive that is meant to improve the taste or aroma impression of food or other substances, and can include both natural and synthetic ingredients.

As used herein, the term “diesel-like” is understood to be an organoleptic descriptor that represents a type of aroma that emulates the odor of diesel fuel.

As used herein, the term “strain” is used to represent various chemovars or cultivars.

As used herein, the term “cultivar” represents a group of similar plants that by structural features and performance (i.e., morphological and physiological characteristics) can be identified from other varieties within the same species. Furthermore, the term “cultivar” variously refers to a variety, strain, or race of plant that has been produced by horticultural or agronomic techniques and is not normally found in wild populations. The terms cultivar, variety, strain, and race are often used interchangeably by plant breeders, agronomists, and farmers.

As used herein, the term “plant matter” is used to represent to any part of a plant including but not limited to the flower bud, leaf, petal, flower, stem, seed, embryo, shoot, root, stipule, ovule, bract, trichome, branch, petiole, internode, bark, pubescence, tiller, rhizome, frond, blade, ovule, pollen, stamen, and the like.

As used herein, the term “dry flower” is understood to mean a flower or bud of the plant matter that has been cured and dried and has less than about 0.63 water activity, or alternatively about 13% moisture by weight of the flower. Dry flower, or dry herb, is what is used for rolling into a smokable composition (i.e. a “joint”) or in an edible form, for example.

In some embodiments the plant matter may be ‘alive’ or ‘wet’ which means it is not cured. Thus, the contents of various components may be measured in terms of dry flow, wet flower, extracts, or otherwise.

“Senecioate” as used herein indicates a ‘3-methylbut-2-enoate’ group having the following structure, where the “ [symbol] ” indicates a bond to another atom or where the O is an anion to be electronically balanced by a cation:

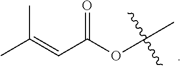 [SMILES: *OC(=O)C=C(C)C]

Various aspects and/or embodiments of this disclosure relate to compositions, products, and methods that are capable of, or adapted to, providing, augmenting, or enhancing the diesel-like odor or aroma. Other aspects and/or embodiments relate to plant species, cultivars, and methods of breeding plant species which include compounds capable of providing diesel-like odor or aroma and/or and modifying the olfactory qualities of the diesel-like aroma. Yet other aspects and/or embodiments relate to methods for analyzing and/or identifying the compounds that contribute to a diesel-like aroma associated with a product.

Disclosed herein is the discovery of previously unreported esters that are posited to contribute to the “diesel” scent found in cannabis, particularly when combined with terpene profiles resembling that of an OG family of cultivars—i.e., myrcene dominant terpene mixtures. These compounds contain the 3-methylbut-2-enoate functional group (i.e., the senecioate group) and constitute a family of compounds with varying alkyl chain. The senecioate functional group can be considered an oxidized prenyl group, wherein the C1 positioned carbon contains a carboxyl group. Some of these compounds may be found in trace amounts, e.g., 0.001% or less, in Cannabis.

The invention is based on the surprising finding that senecioate compounds, e.g., alkyl senecioates, are capable of contributing to, generating or imparting signature aromas and scents to compositions, including cannabis-based compositions. Senecioates, alone or in combination with the major terpenes (e.g., D-Limonene, Terpinolene, Linalool, and Pinene), and optionally along with other organosulfur compounds (e.g., prenylated volatile sulfur compounds), generate unexpectedly unique flavors and aromas, which can be used to impart fragrance and flavor to a wide variety of consumer products. Instead of taking on the more traditional aromas, the senecioate compound was surprisingly and unexpectedly found to play a key role in the characteristic aroma found in cannabis and to elevate the unique sensory aspects of many varieties with divergent aromas.

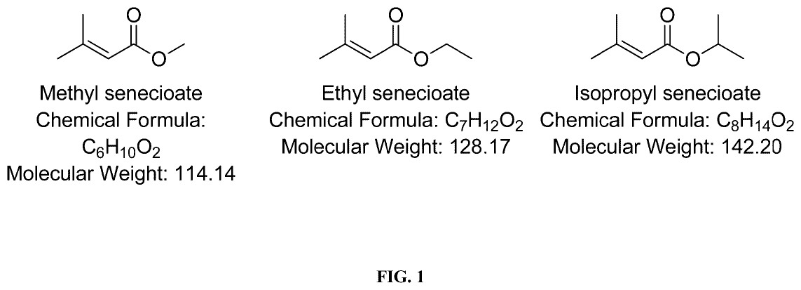

Described herein are aroma compositions which include senecioic acid salts, e.g., alkyl senecioates. Examples of the alkyl senecioates include, but are not limited to, saturated alkyl esters of senecioic acid such as methyl senecioate, ethyl senecioate, n-propyl senecioate, n-butyl senecioate isoamyl senecioate, n-hexyl senecioate; and unsaturated alkyl esters of senecioic acid such as vinyl senecioate and isopropenyl senecioate. Provided herein are compositions including one or more ester compounds such as methyl senecioate, ethyl senecioate, isopropyl senecioate, n-propyl senecioate, n-butyl senecioate, isoamyl senecioate, n-hexyl senecioate, and the like, or a combination of two or more thereof. Structures of illustrative senecioate compounds are illustrated in FIG. 1.

In certain embodiments, the one or more aroma compounds are ester compounds such as methyl senecioate, ethyl senecioate, isopropyl senecioate, n-propyl senecioate, n-butyl senecioate, isoamyl senecioate, n-hexyl senecioate may be present at up to about 20% by weight of the total composition, up to about 15%, up to about 10%, up to about 5%, up to about 2%, up to about 1%, up to about 0.6%, up to about 0.5%, up to about 0.3%, up to about 0.2% or up to about 0.1% by weight of the total weight of the composition. For example, the ester compound, i.e., senecioate compound, may be present in the composition from at least about 0.008% by weight of the total composition, at least about 0.009%, at least about 0.01%, at least about 0.012%, at least about 0.015%, at least about 0.018%, at least about 0.02%, at least about 0.03%, at least about 0.04%, at least about 0.05% or at least about 0.1% by weight. This includes where the ester compound is present from about 0.01% to about 10% of the total weight of the composition, including without limitation, about 0.01% to about 5%, about 0.01% to about 3%, about 0.01% to about 2%, or about 0.01% to about 1%, about 0.01% to about 0.5%, about 0.01% to about 0.2%, about 0.01% to about 0.1%, 0.02% to about 5%, about 0.02% to about 3%, about 0.02% to about 2%, or about 0.02% to about 1%, about 0.02% to about 0.5%, about 0.02% to about 0.2%, about 0.02% to about 0.1%, by weight of the total weight of the composition, or any range including and/or in-between any two of these values. In certain embodiments, the composition includes about 0.01% and 1% of the ester compound, based on the total weight of the composition.

The composition may include about 0.01 wt. % to about 10 wt. %, about 0.01 wt. % to about 5 wt. %, about 0.01 wt. % to about 3 wt. %, about 0.01 wt. % to about 2 wt. %, about 0.01 wt. % to about 1 wt. %, about 0.01 wt. % to about 0.5 wt. %, about 0.1 wt. % to about 1 wt. %, about 0.1 wt. % to about 1 wt. %, about 0.1 wt. % to about 0.8 wt. %, or about 0.1 wt. % to about 0 . . . 5 wt. %, of the total weight of the composition, of one or more ester compounds such as methyl senecioate, ethyl senecioate, isopropyl senecioate, n-propyl senecioate, n-butyl senecioate, isoamyl senecioate, n-hexyl senecioate, and the like, or a combination of two or more thereof. Various combinations of ester compounds may also be used in the compositions. In certain embodiments, the composition includes about 0.01 wt % to about 10 wt % of the ester compound, based on the total weight of the composition. In certain embodiments, the composition includes about 0.01 wt % to about 5 wt % of the ester compound, based on the total weight of the composition. In certain embodiments, the composition includes about 0.01 wt % to about 1 wt % of the ester compound, based on the total weight of the composition. In certain embodiments, the composition includes about 0.01 wt % to about 0.5 wt % of the ester compound, based on the total weight of the composition.

For compositions described herein and containing ester compound alone or in combination with terpenes and/or organosulfur compounds, the composition or combination of ester compound and terpene is not a combination found in nature, that is, ester compound does not naturally occur with the terpene and/or organosulfur compounds, or does not occur in nature in the amounts and or ratios described herein. Thus, the composition is not a naturally occurring composition or one that is found in nature.

In addition to the senecioate ester compounds, in certain embodiments, the compositions may include one or more terpene compounds. Non-limiting examples of terpene compounds include hemiterpenes, monoterpenes, sesquiterpenes, diterpenes, sesterterpenes, triterpenes, sesquarterpenes, tetraterpenes, polyterpenes, terpenoids and noriso-prenoids. Suitable terpene compounds may include a primary terpene compound and a secondary terpene compound. Illustrative primary and secondary terpene compounds include, without limitation, myrcene, β-caryophyllene, α or β-Pinene, α or β-phellandrene, limonene, terpinolene, linalool, pinene, terpineol, fenchyl alcohol, α-bisabolol, camphene, terpinolene, humulene, geraniol, camphor, α or β-cedrene, 1-menthol, cis-β-ocimene, trans-β-ocimene, α or β-terpinene, delta-3-carene, borneol, isoborneol, nerol, valencene, farnesene (t), fenchone, ocimene, bergotamene, thujene, ylangene, sabinene, sabinene hydrate, trans-alpha-bergamotene, and the like, or a combination of any two or more thereof. Many other terpenes are known in the art, are commercially available, and can be used in the compositions.

In certain embodiments, the primary terpene compounds may include, without limitation, myrcene, β-caryophyllene, limonene, α-pinene, β-pinene, valencene, ocimene and terpinolene, and the like, or a combination of any two or more thereof. In certain embodiments, the primary terpene compounds constitute a major amount of the total terpene content or is a major contributor to the resulting aroma of the composition. In certain embodiments, the primary terpene compounds constitute at least about 5% by weight of the total composition, at least about 10%, at least about 20%, at least about 30%, at least about 40%, at least about 50%, at least about 60%, at least about 70%, at least about 80% or at least about 90% by weight. In certain embodiments, the primary terpene compounds constitute up to about 99.99% by weight of the total composition, up to about 99%, up to about 95%, up to about 92%, up to about 90%, up to about 85% or up to about 80% by weight of the total weight of the composition. In certain embodiments, the primary terpene compound constitutes about 5% to about 99.99% of the total weight of the composition, including without limitation, about 10% to about 98%, about 20% to about 98%, about 30% to about 98%, about 40% to about 98%, about 50% to about 95%, about 60% to about 90%, or about 70% to about 85% of the total weight of the composition, or any range including and/or in-between any two of these values.

In certain embodiments, the primary terpene compound is present in an amount of from about 0.1 wt. % to about 90 wt. %, based on the total weight of the composition. In certain embodiments, the composition includes about 0.1 wt. % to about 90 wt. % of the total weight of the composition, of myrcene. In certain embodiments, the composition includes about 0.1 wt. % to about 90 wt. % of the total weight of the composition, of β-caryophyllene. In certain embodiments, the composition includes about 0.1 wt. % to about 90 wt. % of the total weight of the composition, of limonene. In certain embodiments, the composition includes about 0.1 wt. % to about 90 wt. % of the total weight of the composition of α-pinene. In certain embodiments, the composition includes about 0.1 wt. % to about 90 wt. % of the total weight of the composition of β-pinene. In certain embodiments, the composition includes about 0.1 wt. % to about 90 wt. % of the total weight of the composition of valencene. In certain embodiments, the composition includes about 0.1 wt. % to about 90 wt. % of the total weight of the composition of ocimene. In certain embodiments, the composition includes about 0.1 wt. % to about 90 wt. % of the total weight of the composition of terpinolene.

In certain embodiments, the compositions include a secondary terpene compound. In certain embodiments, the secondary terpene compounds may include, without limitation, humulene, linalool, α-bisabolol, bisabolene, nerol, α-phellandrene, α-terpineol, farnesene, fenchyl alcohol, geraniol, menthol, cadinene, citronellol, citronellal, citronellyl acetate, geranyl acetate, nerolidol, citral, and the like, or a combination of any two or more thereof. In certain embodiments, the secondary terpene compounds constitute a minor amount of the total terpene content or is a minor contributor to the resulting aroma of the composition. In certain embodiments, the secondary terpene compounds constitute up to about 30% by weight of the total composition, up to about 20%, up to about 10%, up to about 5%, up to about 2%, up to about 1% or up to about 0.1% by weight of the total weight of the composition. In certain embodiments, the secondary terpene compounds constitute at least about 0.0001% by weight of the total composition, at least about 0.001%, at least about 0.01%, at least about 0.1%, at least about 0.5%, at least about 1% or at least about 2% by weight. In certain embodiments, the secondary terpene compound constitutes about 0.0001% to about 30% of the total weight of the composition, including without limitation, about 0.001% to about 25%, about 0.1% to about 20%, about 1% to about 10%, or about 2% to about 5% of the total weight of the composition, or any range including and/or in-between any two of these values. In certain embodiments, the secondary terpene compound is present in an amount of from about 0.01 wt. % to about 10 wt. %, based on the total weight of the composition.

In certain embodiments, the secondary terpene compound is present in an amount of from about 0.1 wt. % to about 30 wt. %, based on the total weight of the composition. In certain embodiments, the composition includes about 0.1 wt. % to about 30 wt. % of the total weight of the composition, of one or more secondary terpenes selected from humulene, linalool, α-bisabolol, nerol, α-phellandrene, α-terpineol, farnesene, fenchyl alcohol, geraniol, menthol, citronellol, citronellal, geranyl acetate, nerolidol and citral.

In addition to the senecioate ester compounds and optionally terpene, in certain embodiments, the compositions may include one or more organosulfur compounds selected from prenyl mercaptan, 2-methylthiophene, 3-methylthiophene, dimethyl disulfide, diprenyl disulfide, 3-methyl-2-buten-1-yl thiolacetate, 3-methyl-1-[(3-methyl-2-buten-1-yl) sulfanyl]-2-butene, prenylmethylsulfide (1-(methylsulfanyl)-3-methyl-2-butene), prenyl thioacetate, thiogeraniol, and dimethyl sulfide, or a combination of any two or more thereof. These organosulfur compounds are added to provide a gassy or skunky feature to the compositions.

In certain embodiments, the composition includes about 0.000001 wt. % to about 10 wt. % of one or more organosulfur compounds based on the total weight of the composition. In certain embodiments, the one or more organosulfur compounds constitute up to about 30% by weight of the total composition, up to about 20%, up to about 10%, up to about 5%, up to about 2%, up to about 1% or up to about 0.1% by weight of the total weight of the composition. In certain embodiments, the one or more organosulfur compounds constitute at least about 0.000001% by weight of the total composition, at least about 0.0001%, at least about 0.001%, at least about 0.01%, at least about 0.1%, at least about 0.5%, at least about 1% or at least about % by weight. In certain embodiments, the organosulfur compound constitutes about 0.0001% to about 30% of the total weight of the composition, including without limitation, about 0.001% to about 25%, about 0.1% to about 20%, about 1% to about 10%, or about 2% to about 5% of the total weight of the composition, or any range including and/or in-between any two of these values. In certain embodiments, the organosulfur compound is present in an amount of from about 0.01 wt. % to about 10 wt. %, based on the total weight of the composition.

In another aspect, the composition can be formulated to have various applications. Generally, the aroma compounds, e.g., the ester compounds described herein is exogenously added to the composition, that is, the composition in itself does not have the aroma compound as native to it. In certain embodiments, the aroma compound, e.g., the ester compound, is natively present in the composition, and selected terpenes in varying amounts are exogenously added to the composition. In a non-limiting way, the composition can be an edible composition, an aerosol composition, a flavor composition, a fragrance composition, or an inhalable composition. In certain embodiments, an edible product including a composition described herein is provided. In certain embodiments, the composition is an edible composition. In certain embodiments, the composition is an aerosol composition. In certain embodiments, the composition is a flavor composition. In certain embodiments, the composition is a fragrance composition. In certain embodiments, the composition is an inhalable composition.

The compositions may further include suitable second flavoring and/or fragrance agents including, but not limited to, indole, ethyl butyrate, ethyl isovalerate, ethyl caprylate, d-fenchone, nonanal, methyl anthranillate, vanillin, ethyl maltol, maltol, strawberry furanone (4-OH-2,5-dimethyl-3-furanone), raspberry ketone (anisyl acetone), isoamyl acetate, isoamyl butyrate, isoamyl hexanoate, isopulegol, (−)-guaiol, ethyl 2-methyl butyrate, ethyl 2-methyl butyrate, ethyl caproate, octanal, octanol, aldehyde c-16, allyl caproate, ortho-tolualdehyde, benzaldehyde, sweet almond oil, bitter almond oil, beta-ionone, hexyl butyrate, hexyl isobutyrate, hexyl acetate, hexyl hexanoate, propyl caproate, folione, citronellyl formate, 2-phenylpropyl isobutyrate, propionyl thiazole, methional, methyl heptadienone, gamma decalactone, melonal, passifloran, methyl-2 butyl acetate, lemon oi, lime terpenes, peppermint oil, orange oil, ylang ylang oil, and the like, or a combination of any two or more thereof. Additional examples of flavoring agents include ingredients that are “generally recognized as safe” (“GRAS”) by the United States Food and Drug Administration (“FDA”), for example, those listed as approved under 21 C.F.R. §§ 172.510, 172.515, and 172.560.

In certain embodiments, the second flavoring and/or fragrance agents, when present, constitutes about 0.000001% to about 90% by weight of the total weight of the composition, including without limitation, about 0.000001% to about 80%, about 0.000001% to about 70%, about 0.000001% to about 60%, about 0.000001% to about 50%, about 0.000001% to about 40%, about 0.000001% to about 30%, about 0.000001% to about 20%, about 0.00001% to about 15%, about 0.0001% to about 10%, about 0.001% to about 8%, about 0.01% to about 5%, about 0.1% to about 3%, or about 1% to about 2% by weight of the total weight of the composition, or any range including and/or in-between any two of these values.

Depending upon the end application, the compositions may include other ingredients, such as surfactants, co-solvents, propellants, other flavoring agents, medicinal agents, perfumes, stabilizers, thickeners, binders, preservatives, emulsifiers, essential oils, water, salt, sweeteners, gelatin, food additives, colorants, excipients, diluents, fatty acids, triglycerides, terpenes, flavanoids and the like or a combination of any two or more thereof. For example the compositions may include other ingredients, such as triacetin, hexanal, decanol, octyl alcohol, methyl amyl ketone, and the like. For example, the compositions may include other phyto-derived compounds, i.e., nitrogenous compounds, amino acids, proteins, enzymes, glycoproteins, hydrocarbons, alcohols, aldehydes, ketones, fatty acids, esters and lactones, steroids, terpenes, non-cannabinoid phenols, flavonoids, vitamins and pigments. In certain embodiments, the compositions may include commonly used terpenes, sesquiterpenes, and their oxygenated derivatives, or cannabinoid products. In certain embodiments, the compositions may include flavor modifiers, fragrance modifiers or a combination thereof. In certain embodiments, the flavor modifiers may include terpene compounds. Illustrative terpene compounds are described herein. In certain embodiments, the terpenes may be exogenously added to the composition or endogenously present in the compositions. In certain embodiments, the terpenes may be exogenously added to the composition.

The aroma compounds and compositions described herein may be used in any flavor and fragrance applications. Accordingly, in one aspect, provided herein are flavor and fragrance compositions including ester compounds including, but not limited to, and a compound such as methyl senecioate, ethyl senecioate, isopropyl senecioate, n-propyl senecioate, n-butyl senecioate, isoamyl senecioate, and n-hexyl senecioate, or the like. The flavor and fragrance compositions may further include terpenes, including, but not limited to the primary terpene compound and secondary terpene compounds described herein. The flavor and fragrance compositions may further include prenyl mercaptan, 2-methylthiophene, 3-methylthiophene, dimethyl disulfide, diprenyl disulfide, 3-methyl-2-buten-1-yl thiolacetate, 3-methyl-1-[(3-methyl-2-buten-1-yl) sulfanyl]-2-butene.

In certain embodiments, the compositions may further include a cannabinoid active agent. The cannabinoid active agent may be selected from any of the known cannabinoids, including, without limitation, tetrahydrocanabinols, tetrahydrocannabinolic acids, cannabidiol, cannabidiolic acid, cannabigerolic acid, cannabigerol, cannabigerovarinic acid, cannabigerolovarin, cannabichromenic acid, cannabichromene, cannabidivarin, cannabidivarinic acid, cannabivarin, cannabivarinic acid, tetrahydrocannabivarinic acid, tetrahydrocannabivarin, cannabinolic acid, cannabinol, cannabinodiol, cannabielsoin, cannabicyclol, and cannabicitran and isomers thereof, or a combination of any two or more thereof. When used, the cannabinoid active agent is present in an amount of from about 0.05% to 99.9% by wt. based on the total weight of composition, including from 0.1 to 45%, 1 to 40%, 2 to 35%, 5 to 30%, or 10 to 20% by wt., based on the total weight of the composition.

The compositions described herein may be used in a variety of products including edible products, aerosol products, fragrance products, flavor products, inhalable products, consumer products, personal care products, and household products. The aroma compound-containing compositions containing one or more ester compounds may synergistically enhance the olfactory effects of products to closely emulate a desired aroma and/or flavor e.g., a fruity aroma and/or flavor. In certain embodiments, the aroma compound-containing compositions can be used as an additive to synergistically enhance the aroma and/or flavor of products such as edible products, aerosol products, fragrance products, flavor products, inhalable products, consumer products, personal care products, and household products. In certain embodiments, the edible product is a food product or a beverage product.

In another aspect, the present technology relates to various products that may include the aroma compound-containing compositions described herein. Illustrative products include, without limitation edible products, aerosol products, fragrance products, flavor products, or inhalable products. In certain embodiments, an edible product including a composition described herein is provided. In certain embodiments, the edible product is a food or beverage product. In certain embodiments, the beverage is beer, any alcohol containing beverage, or other non-alcohol containing beverage product. In certain embodiments, a flavor and fragrance product including a composition described herein is provided. In certain embodiments, an inhalation product including the composition described herein is provided. In certain embodiments, the inhalation product is a vaping composition. In certain embodiments, a flavor and/or fragrance delivery system including the composition described herein is provided.

In another aspect, an edible product or an inhalation product includes a composition including one or more ester compounds such as methyl senecioate, ethyl senecioate, isopropyl senecioate, n-propyl senecioate, n-butyl senecioate, isoamyl senecioate, n-hexyl senecioate, and the like, or a combination of two or more thereof. In certain embodiments, the composition includes from about 0.01 wt. % to about 10 wt. % of one or more ester compounds such as methyl senecioate, ethyl senecioate, isopropyl senecioate, n-propyl senecioate, n-butyl senecioate, isoamyl senecioate, and n-hexyl senecioate, based on the total weight of the composition. In certain embodiments, the composition includes from about 0. 001 wt. % to about 0.5 wt. % of one or more ester compounds such as methyl senecioate, ethyl senecioate, isopropyl senecioate, n-propyl senecioate, n-butyl senecioate, isoamyl senecioate, and n-hexyl senecioate, based on the total weight of the composition.

In another aspect, the present technology relates to various products that may include the compositions described herein. Illustrative products include, but are not limited to edible products, aerosol products, fragrance products, flavor products, or inhalable products. In certain embodiments, an edible product including a composition described herein is provided. In certain embodiments, the edible product is a food or beverage product. In certain embodiments, the food product may include candy, licorice, taffy, chews, gummies, jelly bean, and the like. In certain embodiments, the beverage is beer, any alcohol containing beverage, or other non-alcohol containing beverage product. In certain embodiments, a flavor and fragrance product including a composition described herein is provided. In certain embodiments, an inhalation product including the composition described herein is provided. In certain embodiments, the inhalation product is a vaping composition. In certain embodiments, a flavor and/or fragrance delivery system including the composition described herein is provided.

Depending upon the end application, the compositions may include other ingredients, such as additives, surfactants, co-solvents, propellants, other flavoring agents, medicinal agents, perfumes, stabilizers, thickeners, binders, preservatives, emulsifiers, essential oils, water, salt, sweeteners, gelatin, food additives, colorants, excipients, diluents, fatty acids, triglycerides, terpenes, flavanoids and the like or a combination of any two or more thereof. For example, the compositions may include other phyto-derived compounds, i.e., nitrogenous compounds, amino acids, proteins, enzymes, glycoproteins, hydrocarbons, alcohols, aldehydes, ketones, fatty acids, esters and lactones, steroids, terpenes, non-cannabinoid phenols, flavonoids, vitamins and pigments. In certain embodiments, the compositions may include commonly used terpenes, sesquiterpenes, and their oxygenated derivatives, or cannabinoid products. In certain embodiments, the compositions may include flavor modifiers, fragrance modifiers or a combination thereof. In certain embodiments, the flavor modifiers may include terpene compounds. Illustrative terpene compounds are described herein. In certain embodiments, the terpenes may be exogenously added to the composition or endogenously present in the compositions. In certain embodiments, the terpenes may be exogenously added to the composition.

Methods for analyzing and/or identifying the compounds that contribute to an aroma associated with a product containing an ester compound such as methyl senecioate, ethyl senecioate, isopropyl senecioate, n-propyl senecioate, n-butyl senecioate, isoamyl senecioate, and n-hexyl senecioate, or the like, are also provided herein. The methods include analyzing the constituents of a product using various devices and methods including, but not limited to, gas chromatography/time-of-flight mass-spectrometer (GC/TOF-MS), two-dimensional gas chromatography-time of flight mass spectrometry (2DGC-TOF MS), flame ionization detector (FID), sulfur chemiluminescence detector (SCD), gas chromatography/mass spectrometry (GC/MS), gas chromatography with atomic emission detector (GC/AED), gas chromatography/flame ionization detection/olfactometry (GC/FID/olfactometry) or high performance liquid chromatography (HPLC), or a combination of any two or more thereof.

Compositions with varying degrees of ester compounds may be analyzed using 2-dimensional gas chromatography equipped with a time-of-flight mass-spectrometer (TOF-MS), flame ionization detector (FID), and a sulfur chemiluminescence detector (SCD). Such ester compounds may include, without limitation, methyl senecioate, ethyl senecioate, isopropyl senecioate, n-propyl senecioate, n-butyl senecioate, isoamyl senecioate, n-hexyl senecioate, or a combination of any two or more thereof.

One aspect of the present technology relates to a method for detecting aroma compounds, e.g., ester compounds, such as methyl senecioate, ethyl senecioate, isopropyl senecioate, n-propyl senecioate, n-butyl senecioate, isoamyl senecioate, and n-hexyl senecioate, by analyzing the headspace gas from a cannabis sample using a gas chromatography. The gas chromatography can be a one- or two-dimensional gas chromatograph coupled a sulfur chemiluminescence detector (SCD). The SCD can be used in conjugation with other detectors such as a flame ionization detector (FID), a mass spectrometer (MS), nitrogen chemiluminescence detector (NCD), a nitrogen phosphorus detector (NPD), an atomic emission detector (AED), a flame photometric detector (FPD), or an electron capture detector (ECD). Suitable samples of the cannabis plant material can be placed in a bottle and the gases in a headspace bottle, can be collected using headspace tools and injected into an FID combined device, using an inert gas such as nitrogen as carrier gas for the gas chromatography, and performing qualitative and quantitative detection through a FID. The cannabis samples can be incubated and agitated at suitable temperature (e.g., 40-150° C.) prior to collection of the headspace gas sample. In some embodiments, the cannabis sample may include cannabis flower material, such as dried flower, dried, and ground flower, a wet flower, or a flower extract. In some embodiments, the flower material may be cured. In some embodiments, the flower material may be uncured.

Illustrative aroma compounds which may be detected or identified using the GC×GC-FID method, may include, without limitation, methyl senecioate, ethyl senecioate, isopropyl senecioate, n-propyl senecioate, n-butyl senecioate, isoamyl senecioate, and n-hexyl senecioate.

Another aspect of the present technology relates to a method for augmenting or enhancing the aroma or taste of a product by adding to the product an ester compound selected from methyl senecioate, ethyl senecioate, isopropyl senecioate, n-propyl senecioate, n-butyl senecioate, isoamyl senecioate, n-hexyl senecioate, or a combination of any two or more thereof. The ester compound may be added in amounts as described herein, for example from about 0.01 wt. % to about 20 wt. %, from about 0.01 wt. % to about 1 wt. %, or from about 0.01 wt. % to about 0.5 wt. %, from about 0.1 wt. % to about 10 wt. %, from about 0.1 wt. % to about 1 wt. %, or from about 0.1 wt. % to about 0.5 wt. %, based on the total weight of the product. In certain embodiments, provided herein is a method for augmenting or enhancing the aroma or taste of a product selected from an edible product, an aerosol product, a fragrance product, a flavor product, and an inhalable product. Certain embodiments relate to a method of enhancing the aroma of a composition, including the addition to the composition of an aroma-enhancing amount of the ester compound, i.e., senecioate compound. Certain embodiments relate to a method of enhancing the flavor of a composition, including the addition to the composition of an flavor-enhancing amount of the ester compound, i.e., senecioate compound. In certain embodiments, the aroma-enhancing or flavor-enhancing amount of the ester compound, i.e., senecioate compound, is ranges from about 0.001 wt. % to about 20 wt. %, from about 0.01 wt. % to about 10 wt. %, from about 0.01 wt. % to about 5 wt. %, from about 0.01 wt. % to about 1 wt. %, or from about 0.01 wt. % to about 0.5 wt. %, and, or any range including and/or in-between any two of these values, based on the total weight of the product. In certain embodiments, addition of the ester compound to a composition or product results in an enhancement or augmentation of the aroma of the composition or product compared to a composition or product which does not include any the ester compound, i.e., senecioate compound or does not include any exogenously added the ester compound, i.e., senecioate compound.

In certain embodiments, the method further includes adding a terpene compound to the product. Suitable terpene compounds may include the primary and secondary terpene compounds described herein. In certain embodiments, the primary terpene compound a compound such as myrcene, β-caryophyllene, limonene, α-pinene, β-pinene, valencene, ocimene, and terpinolene. In certain embodiments, the secondary terpene compound is one such as humulene, linalool, α-bisabolol, nerol, cx-phellandrene, α-terpineol, farnesene, fenchyl alcohol, geraniol, menthol, citronellol, citronellal, geranyl acetate, nerolidol, and citral. In certain embodiments, the primary terpene compound is added in an amount of from about 0.1 wt. % to about 90 wt. %, based on the total weight of the product. In certain embodiments, the secondary terpene compound is added in an amount of from about 0.01 wt. % to about 10 wt. %, based on the total weight of the composition.

The present invention, thus generally described, will be understood more readily by reference to the following examples, which are provided by way of illustration and are not intended to be limiting of the present invention.

### EXAMPLES

Various embodiments will be further clarified by the following examples, which are in no way intended to limit this disclosure thereto.

The senecioate aroma compounds have been identified in numerous varieties of cannabis that have exotic aromas as shown in Table 1.

TABLE 1
Strains, compounds, and aromas.

| | | Dominant | |
|---|---|---|---|
| Strain | Compounds | Terpene | Aroma |
| Snowdream | Methyl senecioate | Limonene | Sweet, floral and |
| | ethyl senecioate | | earth, candy |
| | isopropyl senecioate | | |
| True | Methyl senecioate | Myrcene | Diesel, strong |
| Classic OG | Ethyl senecioate | | gasoline, earth |
| Pobanz OG | Methyl senecioate | Myrcene | Strong diesel notes |
| | Ethyl senecioate | | with slightly |
| | Isopropyl senecioate | | sweetness |

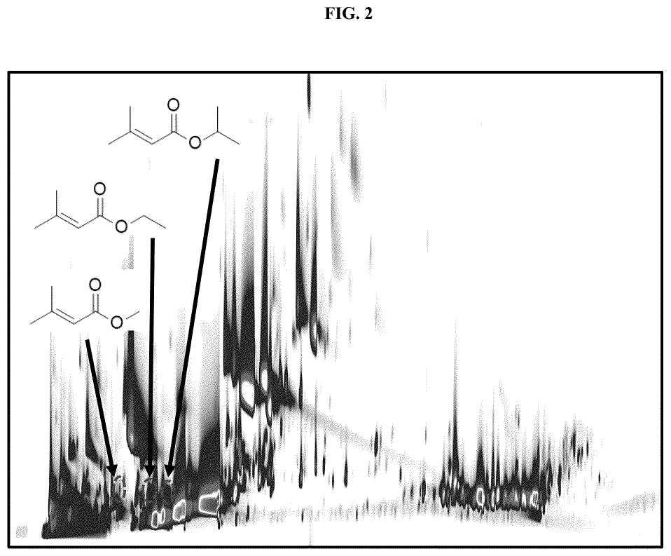

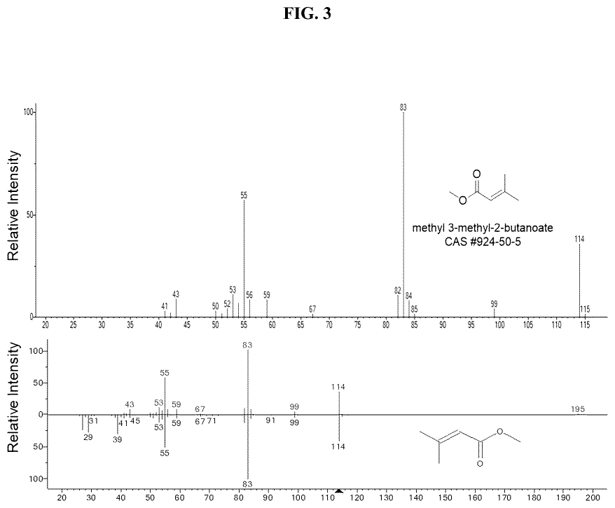

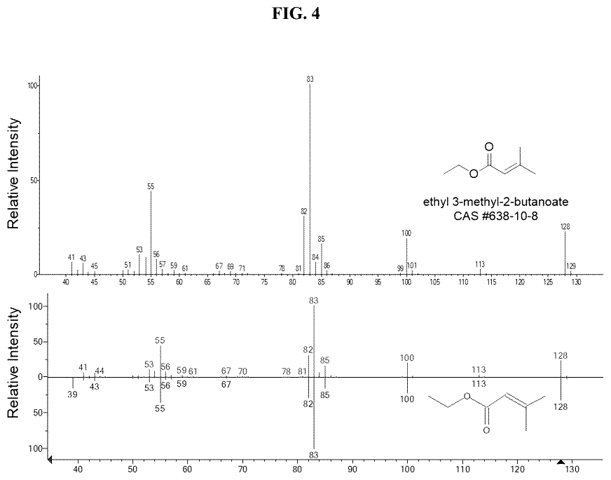

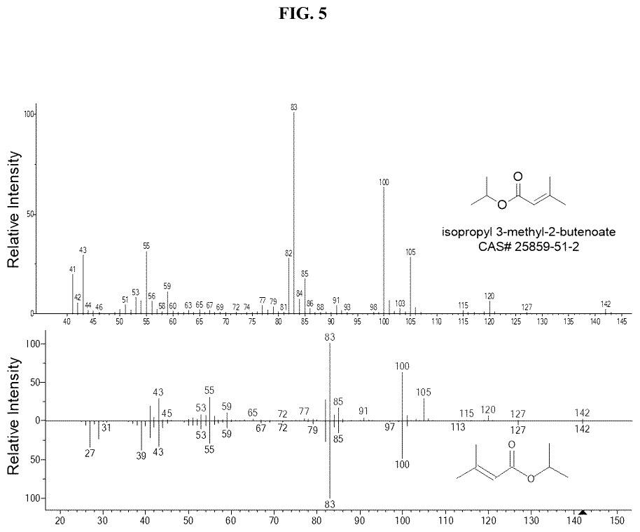

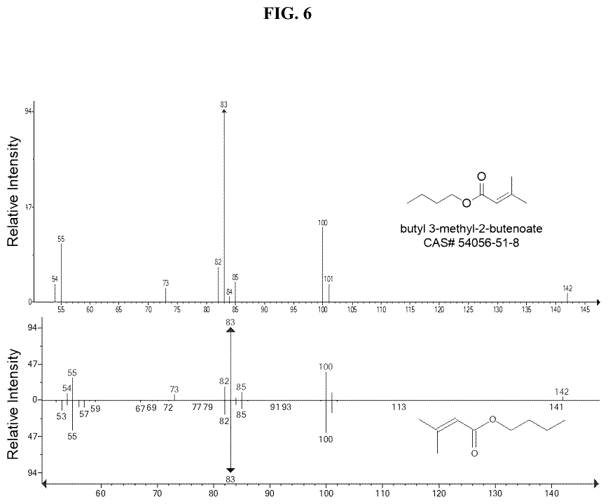

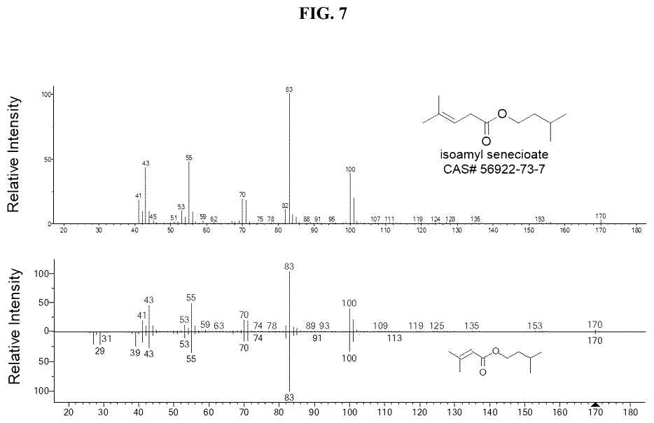

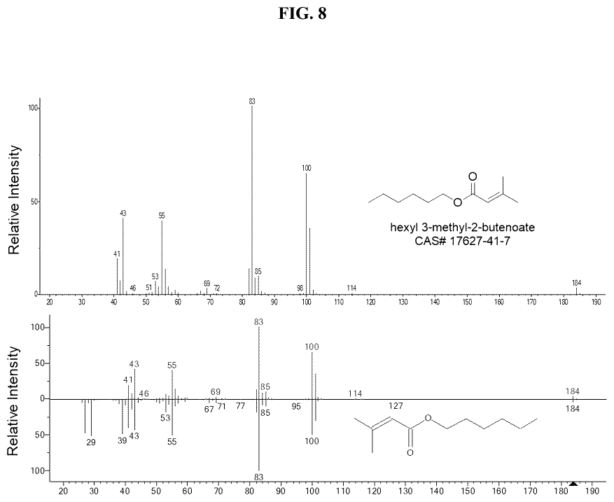

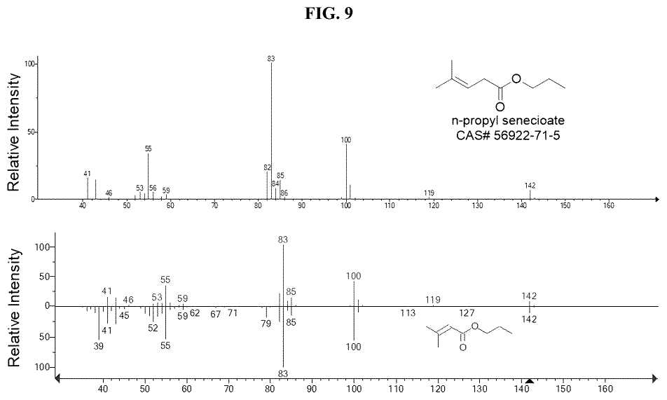

FIG. 2 highlights where these compounds were identified in the variety Snowdream. These compounds can be found in various cannabis samples with different dominant terpenes. For instance, in Snowdream, the aroma has minimal diesel notes even though these compounds are present. This is primarily because the terpene profile is dominated by Limonene and is more congruent with a hybrid cannabis aroma profile. However, in cases where myrcene is the dominant terpene, such as that found in True Classic OG and Pobanz OG, it was found that these compounds strongly modulate the scent to have a deep, diesel aroma. Organoleptic testing of these senecioate compounds in conjunction with the major terpenes in cannabis confirms this observation, further indicating that these compound are key drivers toward the diesel notes often noted in certain cannabis cultivars. The chemical identities of the compounds of interest were determined by analyzing and comparing their mass spectral data, which is depicted in FIGS. 3-9.

The isopropyl, n-propyl, n-butyl, isoamyl, and n-hexyl analogues were not available commercially and were synthesized using the methods described herein. Sensory analysis of the compounds revealed that each possesses a similar, fruity, fusel base note with different nuances. For instance, the isopropyl and n-propyl senecioates were found to be fusel, sweet, whereas the n-butyl and isoamyl senecioates contained notes of banana. The n-hexyl analogue was found to have a green apple top note, which correlates with other compounds containing hexyl chains such as hexyl acetate. These compounds are found in many varieties ranked highly by their exotic score, such as Starburst 36 #1 and Motornana, with the ethyl and isopropyl typically found in the highest concentrations.

### Example 1. General Method for Synthesis of Senecioates

In each esterification, 3-methyl-2-butenoic acid (1 equiv.) was dissolved in dichloromethane at room temperature. 4-Dimethylaminopyridine (0.085 equiv.) and 4 equivalents of a respective alcohol (e.g., n-propanol, isopropanol, n-butanol, isoamyl alcohol, or n-hexanol, and the like) was then added. The reaction solution was cooled in an ice bath before adding N,N′-dicyclohexylcarbodiimide (1.2 equiv). This addition of the coupling reagent led to a precipitate forming as the reaction progressed. After 24 h, the reaction mixture was filtered and the organic layer was washed with aqueous 0.5 N HCl, saturated sodium bicarbonate, and dried over magnesium sulfate. The organic layer was filtered and concentrated. The crude material was purified by column chromatography using silica gel and eluted with a mixture of hexane:diethyl ether (e.g., 90:10 ratio).

After drying the purified material under high-vacuum pressure, the senecioates were analyzed by one or more of GC, FTIR, 1H NMR, 13C NMR spectroscopy. Each of FTIR traces indicated an ester formed by the carbonyl stretch at ˜1700 cm-1. The ester resonance may also be confirmed in the 13C NMR of each target compound at ˜166 ppm. Lastly, the aliphatic chains of the respective alcohols in the esterification coupling were readily identified in both the 1H and 13C spectra.

### Example 2. Two-Dimensional GC Analysis

Comprehensive two-dimensional gas chromatography. GC×GC analysis was performed using the INSIGHT™ reverse fill flush flow modulator (SepSolve Analytical). This was coupled for data generation to an Agilent 7890B GC equipped with a BPX5 (20 m×0.18 mm ID×0.18 μm film thickness) 1st dimension column and Mega Wax (4.8 m×0.32 mm ID×0.15 μm film thickness) 2nd dimension column and BenchTOF Select Time of flight mass spectrometer (Markes International). Time-of-Flight Mass spectrometry (TOF-MS) was used to identify compounds. Quantification of compounds was done using a flame ionization detector (FID). Sample introduction was done using direct injection with an Agilent 7693 Injector Tower (G4513A). The needle was washed 3 times with isopropanol and hexanes before and after injection. The Injection volume used was 5 μL. The inlet split flow and temperature were 20:1 and 280° C., respectively. The TOF-MS detector source was held at 280° C. and transfer line temperature of 260° C. A solvent delay of 6 min. was used and had an acquisition rate of 60 Hz.

The GC×GC column configuration was an apolar to polar setup. The GC oven ramp rates used were as follows: The oven was initially set to 45° C. and held for 3 min. The oven was then ramped at a rate of 3° C. per minute to 98° C., followed by a 6° C. per minute ramp rate to 140° C., followed by a 8.5° C. per minute ramp rate to 170° C. followed by a 2° C. per minute ramp rate to 190° C., followed lastly by a 15° C. per minute ramp to 260° C. and held for 13 minutes to remove any remaining compounds from the column. The modulation period set for the flow modulator was 6.0 s. was collected, integrated, and analyzed using the ChromSpace software platform (Sepsolve Analytical). Statistical analysis and data transformations were done using Terplytics.

Table 2 shows the complete list of standards used and their calibration statistics. 5 or 6-point Calibration curves are used to quantify the compounds.

TABLE 2
Calibration curve data of analytes used to quantify ester compounds in samples

| | | | | | | LOD* | LOQ* |
|---|---|---|---|---|---|---|---|
| Compound name | ¹t_{R} | ²t_{R} | slope | intercept | R² | (μg/mL) | (μg/mL) |
| Methyl senecioate | 10.612 | 4.603 | 109911.6 | −108898 | 0.9979 | 0.0047 | 0.0143 |
| Ethyl senecioate | 14.136 | 4.417 | 69009.72 | −32693.6 | 0.9982 | 0.0082 | 0.0249 |
| Isopropyl senecioate | 15.84 | 4.024 | 202562.4 | −298181 | 0.9970 | 0.0021 | 0.0065 |
| n-Propyl senecioate | 18.9 | 4.259 | 206547.8 | −411672 | 0.9897 | 0.0068 | 0.0206 |
| n-Butyl senecioate | 23.533 | 3.774 | 213179.1 | −430589 | 0.9869 | 0.0026 | 0.0078 |
| Isoamyl senecioate | 25.8 | 3.529 | 264590.5 | −376932 | 0.9947 | 0.0052 | 0.0158 |
| n-hexyl senecioate | 29.7 | 3.068 | 225563.3 | −321843 | 0.9883 | 0.0052 | 0.0157 |

*LOD and LOQ are defined by the equations:
$LOD = \frac{3.3 \cdot σ}{s} ;$ $LOQ = \frac{10 \cdot σ}{s}$ where σ is the standard deviation of the region in the chromatogram for each analyte from seven hexane blanks and S is the slope of the curve.

GC×GC-FID chromatograms can be realigned to account for void time (2.5 s) in the second dimension. Analyte concentrations can be found in Table 3. Relative amounts of the volatile fraction for each analyte can be found in Table 4. Correlation matrices for sensory analysis and chemical analysis with Pearson correlation coefficients can be plotted.

TABLE 3
Analyte concentrations (μg/mg).

| Compound | | | Grape Pie × | Juice | Papaya | Cake | Starburst | Upsidedown |
|---|---|---|---|---|---|---|---|---|
| name | type | subtype | Do-Si-Do | Man | Peach | Crasher | 36 #1 | frown #5 |
| Exotic score | NA | NA | 87.4 | 87.1 | 86.3 | 83.7 | 81.7 | 80.7 |
| ethyl | flavorant | ester | 0.1687 | 0.1576 | 0.1243 | 0.1039 | 0.4156 | 0.0102 |
| senecioate | | | | | | | | |
| n-butyl | flavorant | ester | 0 | 0 | 0 | 0.0449 | 0.0404 | 0 |
| senecioate | | | | | | | | |
| n-propyl | flavorant | ester | 0 | 0.0398 | 0.0386 | 0.0396 | 0.0474 | 0 |
| senecioate | | | | | | | | |
| isoamyl | flavorant | ester | 0.0286 | 0 | 0.0392 | 0 | 0.03 | 0 |
| senecioate | | | | | | | | |
| n-hexyl | flavorant | ester | 0.027 | 0 | 0 | 0 | 0.0309 | 0.0631 |
| senecioate | | | | | | | | |
| isopropyl | flavorant | ester | 0.0319 | 0 | 0.0299 | 0.035 | 0.0458 | 0 |
| senecioate | | | | | | | | |
| methyl | flavorant | ester | 0 | 0 | 0 | 0 | 0 | 0 |
| senecioate | | | | | | | | |

| Compound | Motor | Garlic | Zkittlez | Banana | Bubblegum | TK × | Purple | Pure |
|---|---|---|---|---|---|---|---|---|
| name | Nana | Cocktail #7 | 710 | Scream | Zkittlez | Butterscotch | Churro | Guava |
| Exotic score | 80.3 | 80.1 | 80.1 | 79.7 | 77 | 76.3 | 74.3 | 74 |
| ethyl | 0.2353 | 0.0118 | 0.015 | 0.0408 | 0.0117 | 0.0396 | 0.0104 | 0.054 |
| senecioate | | | | | | | | |
| n-butyl | 0 | 0.0466 | 0.04 | 0.0393 | 0 | 0 | 0.0385 | 0.0419 |
| senecioate | | | | | | | | |
| n-propyl | 0.05 | 0 | 0 | 0.0392 | 0 | 0 | 0 | 0 |
| senecioate | | | | | | | | |
| isoamyl | 0.0284 | 0.0313 | 0.0281 | 0.0275 | 0.0283 | 0 | 0.0273 | 0.0337 |
| senecioate | | | | | | | | |
| n-hexyl | 0.0291 | 0 | 0.0297 | 0 | 0.0289 | 0.0389 | 0 | 0.0306 |
| senecioate | | | | | | | | |
| isopropyl | 0.0307 | 0 | 0 | 0 | 0 | 0.0323 | 0 | 0.0315 |
| senecioate | | | | | | | | |
| methyl | 0 | 0 | 0 | 0 | 0 | 0 | 0 | 0.0334 |
| senecioate | | | | | | | | |

| Compound | Rainbow | Fruity | OPP × | Gorilla | Bubba | | Bacio | MAC |
|---|---|---|---|---|---|---|---|---|
| name | 2.0 | Pebbles | Smarties | Glue | Kush | Trainwreck | Gelato | 1 |
| Exotic score | 71.6 | 71.4 | 70.9 | 65.1 | 62.1 | 43.7 | 43.1 | 39.3 |
| ethyl | 0.0513 | 0.0641 | 0.0248 | 0.0119 | 0.0349 | 0.0146 | 0.2033 | 0.0167 |
| senecioate | | | | | | | | |
| n-butyl | 0 | 0 | 0 | 0 | 0.0379 | 0 | 0 | 0.0401 |
| senecioate | | | | | | | | |
| n-propyl | 0 | 0.0377 | 0 | 0 | 0 | 0 | 0 | 0 |
| senecioate | | | | | | | | |
| isoamyl | 0.0287 | 0.0267 | 0.0279 | 0 | 0.0272 | 0 | 0 | 0.0286 |
| senecioate | | | | | | | | |
| n-hexyl | 0.0286 | 0.0276 | 0.0293 | 0.0292 | 0.0329 | 0 | 0.0278 | 0 |
| senecioate | | | | | | | | |
| isopropyl | 0.0301 | 0.0331 | 0.0292 | 0 | 0.0481 | 0 | 0.0312 | 0 |
| senecioate | | | | | | | | |
| methyl | 0 | 0 | 0 | 0 | 0.0235 | 0 | 0.0366 | 0 |
| senecioate | | | | | | | | |

| Compound | | Kimbo | Lucky | Pie | Cookies and | GMO | | 710 | |
|---|---|---|---|---|---|---|---|---|---|
| name | Gelato 33 | Kush | Charms | Hoe | Cream | Cookies | OG | chem | GMO |
| Exotic score | 34.6 | 34 | 30.7 | 25.3 | 15.4 | 5.7 | 3 | 1.9 | 1.7 |
| ethyl | 0.1454 | 0.0101 | 0.0098 | 0.0376 | 0.2098 | 0.0975 | 0 | 0.027 | 0.0172 |
| senecioate | | | | | | | | | |
| n-butyl | 0 | 0.0404 | 0.0381 | 0.0382 | 0 | 0 | 0 | 0.0431 | 0.0395 |
| senecioate | | | | | | | | | |
| n-propyl | 0 | 0 | 0 | 0 | 0.0393 | 0 | 0 | 0 | 0 |
| senecioate | | | | | | | | | |
| isoamyl | 0 | 0 | 0.0271 | 0.0273 | 0.0271 | 0.0284 | 0 | 0.0293 | 0.028 |
| senecioate | | | | | | | | | |
| n-hexyl | 0.0277 | 0 | 0 | 0.029 | 0.0266 | 0.0374 | 0 | 0 | 0.0293 |
| senecioate | | | | | | | | | |
| isopropyl | 0.0301 | 0 | 0 | 0.0309 | 0.0291 | 0 | 0 | 0 | 0.0305 |
| senecioate | | | | | | | | | |
| methyl | 0.0302 | 0 | 0 | 0.0236 | 0.0228 | 0.0257 | 0 | 0 | 0.0335 |
| senecioate | | | | | | | | | |

TABLE 4
Analyte Relative-% of volatile fraction

| Compound | | | Grape Pie × | Juice | Papaya | Cake | Starburst | Upsidedown |
|---|---|---|---|---|---|---|---|---|
| name | type | subtype | Do-Si-Do | Man | Peach | Crasher | 36 #1 | frown #5 |
| Exotic score | NA | NA | 87.4 | 87.1 | 86.3 | 83.7 | 81.7 | 80.7 |
| ethyl | flavorant | ester | 0.2084 | 0.196 | 0.1312 | 0.0933 | 0.5852 | 0.0211 |
| senecioate | | | | | | | | |
| n-butyl | flavorant | ester | 0 | 0 | 0 | 0.0403 | 0.0569 | 0 |
| senecioate | | | | | | | | |
| n-propyl | flavorant | ester | 0 | 0.0495 | 0.0407 | 0.0355 | 0.0667 | 0 |
| senecioate | | | | | | | | |
| isoamyl | flavorant | ester | 0.0354 | 0 | 0.0414 | 0 | 0.0423 | 0 |
| senecioate | | | | | | | | |
| n-hexyl | flavorant | ester | 0.0334 | 0 | 0 | 0 | 0.0434 | 0.1304 |
| senecioate | | | | | | | | |
| isopropyl | flavorant | ester | 0.0394 | 0 | 0.0315 | 0.0314 | 0.0645 | 0 |
| senecioate | | | | | | | | |
| methyl | flavorant | ester | 0 | 0 | 0 | 0 | 0 | 0 |
| senecioate | | | | | | | | |

| Compound | Zkittlez | Banana | Bubblegum | TK × | Purple | | Rainbow | Fruity |
|---|---|---|---|---|---|---|---|---|
| name | 710 | Scream | Zkittlez | Butterscotch | Churro | Pure Guava | 2.0 | Pebbles |
| Exotic score | 80.1 | 79.7 | 77 | 76.3 | 74.3 | 74 | 71.6 | 71.4 |
| ethyl | 0.0105 | 0.0437 | 0.0153 | 0.0406 | 0.011 | 0.0723 | 0.0597 | 0.0978 |
| senecioate | | | | | | | | |
| n-butyl | 0.0281 | 0.0421 | 0 | 0 | 0.0409 | 0.0561 | 0 | 0 |
| senecioate | | | | | | | | |
| n-propyl | 0 | 0.042 | 0 | 0 | 0 | 0 | 0 | 0.0576 |
| senecioate | | | | | | | | |
| isoamyl | 0.0198 | 0.0295 | 0.0371 | 0 | 0.029 | 0.0452 | 0.0334 | 0.0408 |
| senecioate | | | | | | | | |
| n-hexyl | 0.0209 | 0 | 0.0378 | 0.0399 | 0 | 0.041 | 0.0333 | 0.0421 |
| senecioate | | | | | | | | |
| isopropyl | 0 | 0 | 0 | 0.0331 | 0 | 0.0421 | 0.035 | 0.0506 |
| senecioate | | | | | | | | |
| methyl | 0 | 0 | 0 | 0 | 0 | 0.0448 | 0 | 0 |
| senecioate | | | | | | | | |

| Compound | OPP × | Gorilla | Bubba | | Bacio | MAC | Gelato | Kimbo | Lucky |
|---|---|---|---|---|---|---|---|---|---|
| name | Smarties | Glue | Kush | Trainwreck | Gelato | 1 | 33 | Kush | Charms |
| Exotic | 70.9 | 65.1 | 62.1 | 43.7 | 43.1 | 39.3 | 34.6 | 34 | 30.7 |
| score | | | | | | | | | |
| ethyl | 0.0329 | 0.0185 | 0.0411 | 0.0255 | 0.2572 | 0.031 | 0.1903 | 0.015 | 0.0114 |
| senecioate | | | | | | | | | |
| n-butyl | 0 | 0 | 0.0446 | 0 | 0 | 0.0744 | 0 | 0.0598 | 0.0444 |
| senecioate | | | | | | | | | |
| n-propyl | 0 | 0 | 0 | 0 | 0 | 0 | 0 | 0 | 0 |
| senecioate | | | | | | | | | |
| isoamyl | 0.0371 | 0 | 0.032 | 0 | 0 | 0.0531 | 0 | 0 | 0.0316 |
| senecioate | | | | | | | | | |
| n-hexyl | 0.0389 | 0.0453 | 0.0387 | 0 | 0.0351 | 0 | 0.0362 | 0 | 0 |
| senecioate | | | | | | | | | |
| isopropyl | 0.0389 | 0 | 0.0566 | 0 | 0.0394 | 0 | 0.0394 | 0 | 0 |
| senecioate | | | | | | | | | |
| methyl | 0 | 0 | 0.0277 | 0 | 0.0463 | 0 | 0.0396 | 0 | 0 |
| senecioate | | | | | | | | | |

| | | | Cookies | | | | | Cookies |
|---|---|---|---|---|---|---|---|---|
| Compound | | | and | GMO | | | | and |
| name | Pie Hoe | MAC 1 | Cream | Cookies | OG | 710 chem | GMO | Cream |
| Exotic score | 25.3 | 39.3 | 15.4 | 5.7 | 3 | 1.9 | 1.7 | 15.4 |
| ethyl | 0.0479 | 0.031 | 0.2558 | 0.0958 | 0 | 0.0331 | 0.0205 | 0.2558 |
| senecioate | | | | | | | | |
| n-butyl | 0.0487 | 0.0744 | 0 | 0 | 0 | 0.0527 | 0.0471 | 0 |
| senecioate | | | | | | | | |
| n-propyl | 0 | 0 | 0.048 | 0 | 0 | 0 | 0 | 0.048 |
| senecioate | | | | | | | | |
| isoamyl | 0.0348 | 0.0531 | 0.033 | 0.0279 | 0 | 0.0359 | 0.0335 | 0.033 |
| senecioate | | | | | | | | |
| n-hexyl | 0.0369 | 0 | 0.0325 | 0.0368 | 0 | 0 | 0.035 | 0.0325 |
| senecioate | | | | | | | | |
| isopropyl | 0.0394 | 0 | 0.0355 | 0 | 0 | 0 | 0.0364 | 0.0355 |
| senecioate | | | | | | | | |
| methyl | 0.0301 | 0 | 0.0278 | 0.0253 | 0 | 0 | 0.04 | 0.0278 |
| senecioate | | | | | | | | |

### Example 3. Synthesis of propan-2-yl 3-methylbut-2-enoate (Isopropyl Senecioate)

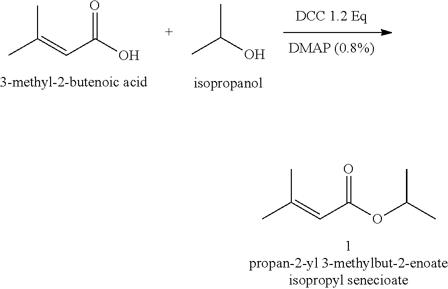

This procedure was carried out open to air. In a 500 mL oven dried round bottom flask (RBF) equipped with a stir bar, 3-methyl-2-butenoic acid (28.87 g, 100 mmol, 1 equiv.) was dissolved in 100 mL dichloromethane (DCM) at room temperature. 4-Dimethylaminopyridine (DMAP) (1.01 g, 8.5 mmols, 0.085 equiv.) was added with isopropanol (31.0 mL, 400 mmols, 4 equiv.). The RBF was placed into an ice bath for five minutes before adding, N,N′-Dicyclohexylcarbodiimide (DCC) (24.70 g, 120 mmols, 1.2 equiv) into the reaction flask. The reaction stirred in an ice bath for another five minutes. During this time, the reaction mixture changed color rapidly from orange to off-white as precipitate forms. The mixture is removed from of the ice bath and continued stirring for 24 hours. The reaction mixture was filtered using a Buchner funnel. Any remaining solids were suspended in DCM and added to the filter. If precipitate passed through the Büchner funnel it was run again until no precipitate was in the resulting solution. The supernatant was partially concentrated using rotary evaporator. The organic solution was transferred to a separation flask and washed twice with aqueous 0.5 N HCl and twice with saturated sodium bicarbonate. Anhydrous magnesium sulfate was added to the organic layer in small increments while stirring. Once the anhydrous magnesium sulfate starts to clump, the solution was filtered.

The crude material was analyzed by TLC, using several different non-polar systems. The TLC plate was eluted using 90:10, Hexane:Diethyl Ether, in a glass chamber. Column chromatography was carried out to purify the crude product. Silica gel was used as the stationary phase and packed with 90:10 Hexane:Diethyl Ether. Normal phase TLC was used again to identify product in the collection test tubes having a Rf value of 0.75. The appropriate samples were concentrated using the roto evaporator and isopropyl senecioate was analyzed using in-house gas chromatography-FID with an internal standard (isoamyl butyrate) to test for purity. The sample was analyzed by mixing 5 μL of the internal standard and 5 μL of compound 1 in 1 mL with hexanes (yield=50-55%).

### Example 4. Synthesis of propyl 3-methylbut-2-enoate (Propyl Senecioate)

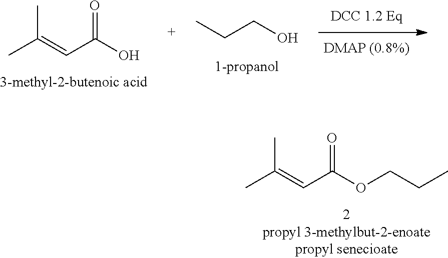

This procedure was carried out open to air. In a 500 mL oven dried round bottom flask (RBF) equipped with a stir bar, 3-methyl-2-butenoic acid (28.9 g, 100 mmol, 1 equiv.) was dissolved in 100 mL dichloromethane (DCM) at room temperature. 4-Dimethylaminopyridine (DMAP) (1.1 g, 8.5 mmols, 0.085 equiv.) was added with 1-propanol (32.0 mL, 400 mmols, 4 equiv.). The RBF was placed into an ice bath for five minutes before adding, N,N′-Dicyclohexylcarbodiimide (DCC) (24.9 g, 120 mmols, 1.2 equiv) into the reaction flask. The reaction stirred in an ice bath for another five minutes. During this time, the reaction mixture changed color rapidly from orange to off-white as precipitate forms. The mixture is removed from of the ice bath and continued stirring for 24 hours. The reaction mixture was filtered using a Buchner funnel. Any remaining solids were suspended in DCM and added to the filter. If precipitate passed through the Büchner funnel it was run again until no precipitate was in the resulting solution. The supernatant was partially concentrated using rotary evaporator. The organic solution was transferred to a separation flask and washed twice with aqueous 0.5 N HCl and twice with saturated sodium bicarbonate. Anhydrous magnesium sulfate was added to the organic layer in small increments while stirring. Once the anhydrous magnesium sulfate starts to clump, the solution was filtered.

### Example 5. Synthesis of butyl 3-methylbut-2-enoate (Butyl Senecioate)

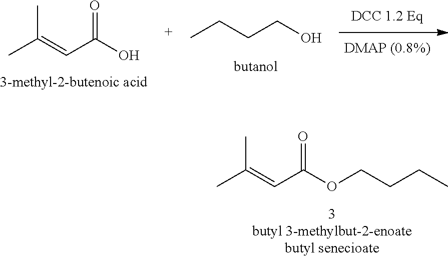

This procedure was carried out open to air. In a 500 mL oven dried round bottom flask (RBF) equipped with a stir bar, 3-methyl-2-butenoic acid (27.8 g, 100 mmol, 1 equiv.) was dissolved in 100 mL dichloromethane (DCM) at room temperature. 4-Dimethylaminopyridine (DMAP) (1.0 g, 8.5 mmols, 0.085 equiv.) was added with butanol (32.0 mL, 400 mmols, 4 equiv.). The RBF was placed into an ice bath for five minutes before adding, N,N′-Dicyclohexylcarbodiimide (DCC) (24.8 g, 120 mmols, 1.2 equiv) into the reaction flask. The reaction stirred in an ice bath for another five minutes. During this time, the reaction mixture changed color rapidly from orange to off-white as precipitate forms. The mixture is removed from of the ice bath and continued stirring for 24 hours. The reaction mixture was filtered using a Buchner funnel. Any remaining solids were suspended in DCM and added to the filter. If precipitate passed through the Büchner funnel it was run again until no precipitate was in the resulting solution. The supernatant was partially concentrated using rotary evaporator. The organic solution was transferred to a separation flask and washed twice with aqueous 0.5 N HCl and twice with saturated sodium bicarbonate. Anhydrous magnesium sulfate was added to the organic layer in small increments while stirring. Once the anhydrous magnesium sulfate starts to clump, the solution was filtered.

The crude material was analyzed by TLC, using several different non-polar systems. The TLC plate was eluted using 90:10, Hexane:Diethyl Ether, in a glass chamber. Column chromatography was carried out to purify the crude product. Silica gel was used as the stationary phase and packed with 90:10 Hexane:Diethyl Ether. Normal phase TLC was used again to identify product in the collection test tubes having a Rf value of 0.45. The appropriate samples were concentrated using the roto evaporator and butyl senecioate was analyzed using in-house gas chromatography-FID with an internal standard (isoamyl butyrate) to test for purity (Yield=55%).

The crude material was analyzed by TLC, using several different non-polar systems. The TLC plate was eluted using 90:10, Hexane:Diethyl Ether, in a glass chamber. Column chromatography was carried out to purify the crude product. Silica gel was used as the stationary phase and packed with 90:10 Hexane:Diethyl Ether. Normal phase TLC was used again to identify product in the collection test tubes having a Rf value of 0.75. The appropriate samples were concentrated using the roto evaporator and propyl senecioate was analyzed using in-house gas chromatography-FID with an internal standard (isoamyl butyrate) to test for purity (Yield=55%).

### Example 6. Sensory Analysis of Botanical Formulations

To determine the aroma characteristics of each senecioate, comparative sensory analysis between six flavor formulations with and without the senecioates was conducted using a blind sensory panel of 6 panelists. The panelists were asked to rank “biomimicry” for each blend.

It was unexpectedly observed that when senecioates are added in sufficient concentration the aroma drastically modify and improve the character of the formulations. In formulations with prenylated VSCs present, the sensory panel noted a large enhancement of the “diesel” aroma many varieties are known for. For those formulations that had a sweeter aroma, such as containing a large number of esters, the candy-like sweetness of many varieties was drastically enhanced relative to the control. When used in levels near the plant, the aroma is extremely muted. However, at levels over ˜10 ppm, a strong enhancement of each of the aforementioned aroma characteristics was found. Tables 5-10 shows the formulated products A-F and their ingredients (senecioates included), while Table 11 shows the sensory test results for those products.

TABLE 5
Product A

| Compound | Wt. Percent |
|---|---|
| 2-methyl butyric acid | 1.0 |
| 2-methyl-2-pentenoic acid | 3 |
| 4-acetoxy-25-dimethyl-3(2h)-furanone | 5 |
| benzaldehyde | 0.1 |
| benzyl benzoate | 0.2 |
| cis-3 hexenol | 4 |
| Citral | 2 |
| ethyl 2-methyl butyrate | 10 |
| ethyl aceto acetate | 5 |
| ethyl butyrate | 13 |
| ethyl caproate | 12 |
| ethyl furanone | 4 |
| ethyl isovalerate | 7 |
| eugenol | 0.1 |
| gamma decalactone | 0.2 |
| geraniol | 0.1 |
| hexenyl cis 3 acetate | 1.0 |
| isoamyl acetate | 5 |
| linalool | 2 |
| maltol isobutyrate | 0.3 |
| peru balsam oil | 1.0 |
| phenyl ethyl alcohol | 0.0 |
| raspberry ketone | 2 |
| strawberry furanone | 10 |
| undecalactone gamma | 1.0 |
| valerian root oil | 0.1 |
| ylang ylang oil no. 3 | 0.8 |
| beta ionone | 0.4 |
| vanilla bean | 0.3 |
| methyl cinnamate | 2.3 |
| benzyl acetate | 5.5 |
| ethyl senecioate | 0.5 |
| isopropyl senecioate | 0.1 |
| n-propyl senecioate | 0.1 |
| n-butyl senecioate | 0.1 |
| isoamyl senecioate | 0.1 |
| hexyl senecioate | 0.1 |

TABLE 6
Product B

| Compound | Wt. Percent |
|---|---|
| alpha-bisabolol | 2 |
| beta-caryophyllene | 20 |
| geraniol | 0.3 |
| d-limonene | 29 |
| linalool | 7 |
| alpha-pinene | 3 |
| beta-pinene | 5 |
| terpineol | 3 |
| camphene | 1 |
| d-camphor | 0.3 |
| delta-3-carene | 0.04 |
| fenchyl alcohol | 3 |
| l-menthol | 0.1 |
| alpha-phellandrene | 0.0 |
| sabinene | 0.1 |
| alpha-terpinene | 0.0 |
| terpinolene | 1 |
| humulene | 0.3 |
| myrcene | 24 |
| isoborneol | 0.04 |
| alpha-cedrene | 0.2 |
| ocimene | 0.1 |
| ethyl senecioate | 0.5 |
| isopropyl senecioate | 0.1 |
| n-propyl senecioate | 0.1 |
| n-butyl senecioate | 0.1 |
| isoamyl senecioate | 0.1 |
| hexyl senecioate | 0.1 |

TABLE 7
Product C

| | Wt. |
|---|---|
| Compound | Percent |
| alpha-bisabolol | 2 |
| humulene | 9 |
| alpha-pinene | 2 |
| terpineol | 2 |
| beta-caryophyllene | 30 |
| beta-pinene | 4 |
| camphene | 1 |
| d-camphor | 0.1 |
| d-limonene | 21 |
| delta-3-carene | 0.5 |
| fenchyl alcohol | 2 |
| geraniol | 0.3 |
| linalool | 9 |
| l-menthol | 0.1 |
| myrcene | 8 |
| Nerol | 0.1 |
| terpinolene | 1 |
| ocimene | 0.2 |
| valencene | 8 |
| ethyl senecioate | 0.5 |
| isopropyl senecioate | 0.1 |
| n-propyl senecioate | 0.1 |
| n-butyl senecioate | 0.1 |
| isoamyl senecioate | 0.1 |
| hexyl senecioate | 0.1 |

TABLE 8
Product D

| Compound | Percent |
|---|---|
| alpha-bisabolol | 2 |
| beta-caryophyllene | 18 |
| geraniol | 0.3 |
| d-limonene | 26 |
| linalool | 6 |
| alpha-pinene | 2 |
| beta-pinene | 5 |
| terpineol | 3 |
| camphene | 1 |
| d-camphor | 0.2 |
| delta-3-carene | 0.04 |
| fenchyl alcohol | 2 |
| l-menthol | 0.1 |
| alpha-phellandrene | 0.04 |
| sabinene | 0.1 |
| alpha-terpinene | 0.04 |
| terpinolene | 1 |
| humulene | 0.3 |
| myrcene | 21 |
| isoborneol | 0.04 |
| cedrene alpha | 0.2 |
| ocimene | 0.1 |
| prenyl mercaptan | 0.1 |
| 2-methylthiophene | 0.02 |
| dimethyl disulfide | 0.01 |
| hexanal | 0.05 |
| ethyl senecioate | 2.5 |
| isopropyl senecioate | 0.5 |
| n-propyl senecioate | 0.5 |
| n-butyl senecioate | 0.5 |
| isoamyl senecioate | 0.5 |
| hexyl senecioate | 0.5 |
| triacetin | 7 |

TABLE 9
Product E

| Compound | Percent |
|---|---|
| decanol | 0.5 |
| hexanol | 0.02 |
| octyl alcohol | 3 |
| methyl amyl ketone | 0.2 |
| delta-3-carene | 0.01 |
| ocimene | 0.02 |
| camphene | 0.4 |
| d-camphor | 0.03 |
| beta-caryophyllene | 25 |
| caryophyllene oxide | 0.3 |
| hexenyl cis 3 isobutyrate | 0.1 |
| trans-alpha-bergamotene | 1 |
| citronellol | 0.3 |
| citronellyl acetate | 0.1 |
| d-limonene | 12 |
| borneol | 0.3 |
| fenchyl alcohol | 0.4 |
| ethyl 2-methyl butyrate | 1 |
| ethyl butyrate | 0.4 |
| ethyl isovalerate | 0.1 |
| ethyl caprylate | 0.1 |
| d-fenchone | 0.5 |
| geraniol | 0.3 |
| hexyl 2-methyl butyrate | 0.0 |
| humulene | 9 |
| indole | 0.01 |
| isoamyl hexanoate | 0.12 |
| isopulegol | 1 |
| bornyl acetate | 0.1 |
| lemon oil | 0.2 |
| linalool | 11 |
| methyl anthranilate | 0.1 |
| methyl caproate | 0.1 |
| methyl isovalerate | 0.1 |
| hexyl acetate | 0.2 |
| hexyl caproate | 3 |
| hexyl isobutyrate | 0.2 |
| hexyl butyrate | 0.4 |
| n-hexyl propionate | 0.2 |
| octyl acetate | 1 |
| nonanal | 0.1 |
| propyl caproate | 0.1 |
| octyl propionate | 0.1 |
| orange oil | 1 |
| prenyl mercaptan | 0.02 |
| sabinene | 0.01 |
| 4-terpineol | 0.03 |
| terpinolene | 0.2 |
| linalool oxide | 0.1 |
| nerolidol | 1 |
| ylang ylang oil no. 3 | 0.1 |
| alpha-bisabolol | 2 |
| cadinene | 4 |
| guaiene | 2 |
| alpha-pinene | 1 |
| alpha-terpinene | 0.02 |
| terpineol | 1 |
| bisabolene | 4 |
| myrcene | 1 |
| beta-pinene | 3 |
| gamma-terpinene | 0.1 |
| ethyl senecioate | 2.5 |
| isopropyl senecioate | 0.5 |
| n-propyl senecioate | 0.5 |
| n-butyl senecioate | 0.5 |
| isoamyl senecioate | 0.5 |
| hexyl senecioate | 0.5 |
| triacetin | 2 |

TABLE 10
Product F

| Compound | Percent |
|---|---|
| Caryophyllene | 25 |
| Linalool | 15 |
| D-Limonene | 14 |
| Humulene | 12 |
| β-Myrcene | 4 |
| α-Bisabolol | 3 |
| β-Pinene | 2 |
| trans-Nerolidol | 2 |
| α-Terpineol | 2 |
| endo-Fenchol | 2 |
| δ-Cadinene | 1 |
| α-Pinene | 1 |
| trans-α-Bergamotene | 1 |
| Caryophyllene oxide | 1 |
| endo-Borneol | 0.5 |
| Camphene | 0.3 |
| Terpinolene | 0.2 |
| γ-Terpinene | 0.1 |
| α-Terpinene | 0.04 |
| Terpinen-4-ol | 0.03 |
| Citronellol | 0.01 |
| Nerol | 0.02 |
| Camphor | 0.02 |
| 3-Carene | 0.02 |
| (−)-Guaiol | 0.02 |
| α-Phellandrene | 0.01 |
| Isoborneol | 0.01 |
| Ethyl n-octanoate | 2 |
| n-Octyl n-butyrate | 1 |
| Fenchone | 1 |
| Methyl octanoate | 0.5 |
| Isopulegol | 0.4 |
| n-Hexyl hexanoate | 0.3 |
| Ethyl hexanoate | 0.3 |
| 2-Heptanone | 0.1 |
| Isopropyl butyrate | 0.1 |
| n-Octyl acetate | 0.1 |
| n-Heptyl n-butyrate | 0.1 |
| n-Propyl hexanoate | 0.05 |
| L-bornyl acetate | 0.05 |
| Geraniol | 0.04 |
| n-Hexyl acetate | 0.04 |
| Methyl anthranilate | 0.03 |
| Ethyl n-butyrate | 0.01 |
| Citronellol acetate | 0.01 |
| 2-Ethyl-1-hexyl acetate | 0.005 |
| Ethyl isovalerate | 0.004 |
| Linalool oxide | 0.003 |
| Nonanal | 0.01 |
| Sulcatone | 0.01 |
| trans-Linalool oxide | 0.01 |
| n-Hexyl propanoate | 0.01 |
| Hexanal | 0.01 |
| Nonanal | 0.01 |
| Ethyl isobutyrate | 0.02 |
| Ethyl heptanoate | 0.02 |
| 1-Hexanol | 0.02 |
| Isoamyl hexanoate | 0.02 |
| Fenchyl acetate | 0.02 |
| 1-Octanol | 0.02 |
| Methyl hexanoate | 0.03 |
| Ethyl 2-methylbutyrate | 0.02 |
| α-Citral | 0.01 |
| cis-3-Decen-1-ol | 0.01 |
| 3 methyl thiopene | 0.01 |
| Prenyl mercaptan | 0.03 |
| ethyl senecioate | 2.5 |
| isopropyl senecioate | 0.5 |
| n-propyl senecioate | 0.5 |
| n-butyl senecioate | 0.5 |
| isoamyl senecioate | 0.5 |
| hexyl senecioate | 0.5 |
| triacetin | 3 |

TABLE 11

| Product | Aroma | |
|---|---|---|
| Code | (no senecioates) | Aroma (with senecioates) |
| Product A | very sweet, jammy, | cannabis like-sweetness, more |
| | fruity, strawberry | muddled in a realistic way, less |
| | | strawberry forward |
| Product B | gas, terpenic, slight | increased diesel notes, sweet, |
| | citrus | gas, intense, more well rounded |
| Product C | gas, slight sweetness, | increased sweetness, candy gas, |
| | citrus top note | more true-to-type |
| Product D | gas, terpenic, musky | increased diesel notes, mild |
| | | sweetness under gas |
| Product E | sweet, berry, | cannabis like-sweetness, less |
| | | defined berry or fruit, more |
| | | well rounded |
| Product F | very sweet, spicy, | cannabis like-sweetness, spicy, |
| | berry, citrus heavy, | less berry, more muddled in a |
| | tropical nuance | realistic, enhanced tropical |
| | | sweetness |

The sensory panel surprisingly and unexpectedly noticed that exogenously added ester compounds, such as ethyl senecioate, isopropyl senecioate, n-propyl senecioate, n-butyl senecioate, isoamyl senecioate and hexyl senecioate, modified each formulation in beneficial ways to provide a more desirable and well-rounded aroma with greater depth and complexity of. It was observed that in each sample, key aromatic attributes such as the cannabis like-sweetness and increased diesel notes were enhanced. The addition of the ester compounds to product formulations such as cannabis, hop extracts and terpene blends thus allows it to not only enhance the aroma of the products, but also qualitatively retain the aroma profile.

While certain embodiments have been illustrated and described, it should be understood that changes and modifications can be made therein in accordance with ordinary skill in the art without departing from the technology in its broader aspects as defined in the following claims.

The embodiments, illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

The present disclosure is not to be limited in terms of the particular embodiments described in this application. Many modifications and variations can be made without departing from its spirit and scope, as will be apparent to those skilled in the art. Functionally equivalent methods and compositions within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions, or biological systems, which can of course vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

Other embodiments are set forth in the following claims.

What is claimed is:

1. A composition comprising:
about 0.01 wt % to about 10 wt % of an ester comprising methyl senecioate, ethyl senecioate, isopropyl senecioate, n-propyl senecioate, n-butyl senecioate, isoamyl senecioate, n-hexyl senecioate, or a combination of any two or more thereof; and
about 0.1 wt % to about 99 wt % of a primary terpene compound comprising β-myrcene, β-caryophyllene, limonene, α-pinene, β-pinene, valencene, ocimene, terpinolene, or a combination of any two or more thereof.

2. The composition of claim 1 comprising about 0.01 wt % to about 5 wt % of the ester compound, based on the total weight of the composition.

3. The composition of claim 1, wherein the primary terpene compound is β-myrcene.

4. The composition of claim 1, wherein the primary terpene compound is present in an amount of about 0.1 wt % to about 95 wt %, based on the total weight of the composition.

5. The composition of claim 1 further comprising a secondary terpene compound comprising humulene, linalool, bisabolol, nerol, phellandrene, terpineol, farnesene, fenchyl alcohol, geraniol, menthol, citronellol, citronellal, geranyl acetate, nerolidol, citral, or a combination of any two or more thereof.

6. The composition of claim 5, wherein the secondary terpene compound is present in an amount of about 0.01 wt % to about 50 wt %, based on the total weight of the composition.

7. The composition of claim 1 further comprising a second flavoring or fragrancing agent, in an amount of about 0.000001% to about 90% by weight, based on the total weight of the composition.

8. The composition of claim 1, wherein the composition is an edible composition, an aerosol composition, a flavor composition, a fragrance composition, or an inhalable composition.

9. The composition of claim 8, which the edible product is a food or beverage product.

10. The composition of claim 9, wherein the beverage is beer, an alcohol containing beverage, or a non-alcohol containing beverage product.

11. The composition of claim 8, wherein the composition is an inhalation composition.

12. The composition of claim 8, wherein the composition is a flavor and/or fragrance composition.

13. A method for augmenting or enhancing the aroma or taste of a product, the method comprising adding to said product about 0.01 wt % to about 10 wt % of an ester compound that is methyl senecioate, ethyl senecioate, isopropyl senecioate, n-propyl senecioate, n-butyl senecioate, isoamyl senecioate, n-hexyl senecioate, or a combination of any two or more thereof, and about 0.1 wt % to about 99 wt % of a primary terpene compound that is β-myrcene, β-caryophyllene, limonene, α-pinene, β-pinene, valencene, ocimene, terpinolene, or a combination of any two or more thereof.

14. The method of claim 13, wherein the product is an edible product, an aerosol product, a flavor product, a fragrance product, or an inhalable product.

15. The method of claim 13, wherein about 0.01 wt % to about 10 wt % of the ester compound, based on the total weight of the composition, is added to the composition.

16. The method of claim 13, wherein about 0.1 wt % to about 95 wt % of the primary terpene compound, based on the total weight of the composition, is added to the composition.
